(19) United States
(12) Patent Application Publication
(10) Pub. No.: US 2023/0324547 A1
(43) Pub. Date: Oct. 12, 2023

(54) METHOD AND A DEVICE FOR EXAMINING THE ENVIRONMENT OF A VEHICLE USING ULTRASONIC SIGNALS

(71) Applicant: ELMOS Semiconductor SE, Dortmund (DE)

(72) Inventor: Egbert Spiegel, Marl (DE)

(73) Assignee: ELMOS Semiconductor SE, Dortmund (DE)

(21) Appl. No.: 18/128,902

(22) Filed: Mar. 30, 2023

(30) Foreign Application Priority Data
Apr. 7, 2022 (EP) 22167168.8

(51) Int. Cl. G01S 15/52; G01S 15/88

(52) U.S. Cl. CPC G01S 15/526; G01S 15/88

(57) ABSTRACT

A method and a device examine an environment of a vehicle by analyzing echo signals generated by reflection of transmitted ultrasonic signals at an object. Two different ultrasonic burst signals are transmitted in a same direction and into a same area of the environment. Timely offset echo signals are created at an object by reflection of the two ultrasonic burst signals. The two echo signals are evaluated to determine different parameters of an object. The distance of the object is calculated based on the echo signal of the ultrasonic burst signal with the lower number of ultrasonic pulses. Based on the echo signal of the ultrasonic burst signal with the higher number of ultrasonic pulses, the velocity can be calculated at which the vehicle and the object move relative to each other in the direction of transmission of both ultrasonic burst signals or opposite thereto.

### CROSS REFERENCE TO RELATED APPLICATIONS

The present patent application claims the priority of European patent application 22 167 168.8 filed on Apr. 7, 2022, the disclosure of which is incorporated by reference in the present patent application in its entirety.

### TECHNICAL FIELD

The disclosure relates to a method and a device for examining the environment of a vehicles by analyzing echo signals of transmitted ultrasonic signals, generated by reflection at an object in the environment of the vehicle.

### BACKGROUND

Ultrasonic measuring systems for examining of the environment of a vehicle, e.g. during a parking process, are generally known (see e.g. WO 02/45998 A2 and WO 2014/180609 A1). In these measuring systems, an ultrasonic transmitter transmits ultrasonic burst signals which have a defined number of ultrasonic pulses following each other at a frequency. If objects are present in the environment of the vehicle into which the ultrasonic burst signal has been transmitted, echo signals are generated by the same because of reflections, which echo signals are received by an ultrasonic receiver. Typically, transmitting and receiving ultrasonic signals is performed by one and the same element, namely an ultrasonic transmitter.

With the known systems, it is possible, e.g., to determine the distance of an object from the vehicle.

### SUMMARY

However, it is sometimes desired to be able to determine more information about the detected object, namely, for example, the speed thereof relative to the vehicle.

It is an object of the disclosure to provide a method and a device for examining the environment of the vehicle for the existence of potential objects, it being possible to determine a plurality of parameters characterizing the object.

In order to achieve the object, the disclosure proposes a method for examining the environment of a vehicle by analyzing echo signals of transmitted ultrasonic signals, generated by reflection at an object in the environment of the vehicle, wherein in the method
an ultrasonic burst signal with a first number of ultrasonic pulses following each other at a frequency and, timely offset from this ultrasonic burst signal, an ultrasonic burst signal with a second number of ultrasonic pulses following each other at the same or a different frequency are respectively transmitted into the same area of the environment of the vehicle and in the same direction by an ultrasonic transmitter within repeating measuring cycles, the second number of ultrasonic pulses being different from the first number of ultrasonic pulses,
timely offset echo signals are created at an object potentially present in said area of the environment of the vehicle by reflection of the two ultrasonic burst signals, which echo signals are received by an ultrasonic receiver, and
the echo signals of both ultrasonic burst signals are evaluated to determine different parameters of an object potentially present in said area of the environment of the vehicle,
the distance of an object potentially present in said area of the environment of the vehicle from the vehicle being calculated based on the echo signal of the ultrasonic burst signal with the lower number of ultrasonic pulses, and
based on the echo signal of the ultrasonic burst signal with the higher number of ultrasonic pulses, the velocity can be calculated at which the vehicle and an object potentially present in said area of the environment of the vehicle move relative to each other in the direction of transmission of both ultrasonic burst signals or opposite thereto.

According to the disclosure, at least two different ultrasonic burst signals are respectively transmitted in repeatedly occurring measuring cycles. These signals differ at least with respect to their lengths, i.e. with respect to their number of pulses, for example. Here, a comparatively short ultrasonic burst signal is used, so as to be able to determine the location at which an object was detected in the environment of the vehicle and the distance of the object from the vehicle based on the echo of said signal. With a certain time offset from the time of transmission of the short ultrasonic burst signal a signal peak occurs in the demodulated echo signal (envelope), wherein the distance of the object from the vehicle can then be calculated from the speed of sound. The longer ultrasonic burst signal is used to be able to calculate the velocity of the object relative to the vehicle in the propagation direction of the ultrasonic burst signal based on the analysis of a Doppler frequency shift in the echo signal. Thus, the spectral (Doppler) shift of this signal in the environment of the object is determined using the second ultrasonic burst signal.

Dividing a measuring cycle into two measuring phases (one measuring phase for the short ultrasonic burst signal and the second measuring phase for the long ultrasonic burst signal) has the advantage that now objects can also be detected in close proximity, if, as is typically the case nowadays, one unit, namely an ultrasonic transducer is used for the ultrasonic transmitter and the ultrasonic receiver.

Phase shifts which can be caused by a plurality of reflectors (for example, swinging arms of a pedestrian), can basically simulate any velocity. However, these are averaged out, as it were, over the length of the long ultrasonic burst signal.

The order in which the two ultrasonic burst signals of different length are transmitted and evaluated, is interchangeable. The measuring phases advantageously follow each other immediately. The time offset determined between the transmission of the short ultrasonic burst signal and the reception of the echo signal peak indicating the existence of an object, can be used in the longer measuring phase to define the position in the echo signal of the longer ultrasonic burst signal at which the echo signal section is to be examined that results from the Doppler shift caused by a movement of the object. The time between the reception of both echo signals is sufficiently short, so that it can be assumed that the object has barely moved on between both measurements.

The advantages of the disclosure can be summarized as follows:
determination of the velocity of an object by means of a combined measuring cycle of two measuring phases.
determination of the velocity of complex objects such as people, for example. Since the echo peaks of a complex object can actually change significantly between two measurements, prior methods hardly allow for an association of the echo peaks of both measurements to the object. According to the disclosure, localizing the object by means of the echo signal of the short ultrasonic burst signal is useful in this regard. In comparison, the influence on the mean Doppler shift when using the long ultrasonic burst signal is small.
estimation of the vehicle velocity by evaluating ground clutter signals, for example.

In practical tests, the disclosure was extensively tested for its suitability for everyday use. In this context, it has shown that the ultrasonic burst signal with the lower number of pulses advantageously comprises 10 to 20 pulses, in particular 16 pulses, and/or a length of 190 μs to 380 μs, in particular 300 μs, and the ultrasonic burst signal with the higher number of pulses advantageously comprises 170 to 220 pulses, in particular 190 pulses, and/or a length of 3.2 ms to 4.0 ms, in particular 3.6 μs. In the practical tests, it has shown that the two ultrasonic burst signals should differ with respect to their length and pulse number by the factor 8 to 15 and preferably by the factor 10.

Typically, the analysis of the echo signals is performed using a signal processing unit.

Thus, according to the disclosure, different ultrasonic burst signals are transmitted. However, this does not necessarily mean that the different signals are necessarily transmitted separately. It is also possible to transmit a single ultrasonic burst signal, but to divide the same into, e.g., two or even more sections and to consider each of these sections as an ultrasonic burst signal in the sense of the disclosure, as it were.

The above object is further achieved, according to the disclosure, with a device for examining the environment of a vehicle by analyzing echo signals of transmitted ultrasonic signals, generated by reflection at an object in the environment of the vehicle, the device comprising:
an ultrasonic transmitter for a timely offset transmission of two ultrasonic burst signals in the same direction into the same area of the environment of the vehicle, the transmission occurring within repeating measuring cycles, one ultrasonic burst signal comprising a first number of ultrasonic pulses following each other at a frequency and the other ultrasonic burst signal comprising a second number of ultrasonic pulses different from the first number and following each other at the same or a different frequency,
an ultrasonic receiver for receiving echo signals of the two ultrasonic burst signals upon reflection at an object potentially present in said area of the environment of the vehicle, and
a signal processing unit for the evaluation of the two echo signals to determine different parameters of an object potentially present in said area of the environment of the vehicle,
the distance of an object potentially present in said area of the environment of the vehicle from the vehicle being calculated based on the echo signal of the ultrasonic burst signal with the lower number of ultrasonic pulses, and
based on the echo signal of the ultrasonic burst signal with the higher number of ultrasonic pulses, the velocity can be calculated at which the vehicle and an object potentially present in said area of the environment of the vehicle move relative to each other, namely in their direction of relative movement or the component thereof that is vertical to the transmission of both ultrasonic burst signals.

### BRIEF DESCRIPTION OF THE DRAWINGS

The disclosure is explained in more detail below by means of an example and with reference to the drawing. In the Figures:

FIG. 1 is a top plan view on the front of a vehicle with ultrasonic transducers arranged in the bumpers thereof,

FIG. 2 shows the temporal course of the operating voltage for the transmission of two different ultrasonic burst signals, present at an ultrasonic transducer, and of the course of the voltage, likewise present at the ultrasonic transducer, during the reception of the echo signals of the two ultrasonic burst signals,

FIG. 3 is an illustration of the envelopes of the temporal courses of a triggering signal and echo signals for both ultrasonic burst signals, the envelopes, i.e., the demodulated signals, are superposed in the diagram, and

FIG. 4 shows the principle of the signal selection for the calculation of the Doppler shift (spectral Doppler distribution in the environment of a moving object).

### DESCRIPTION

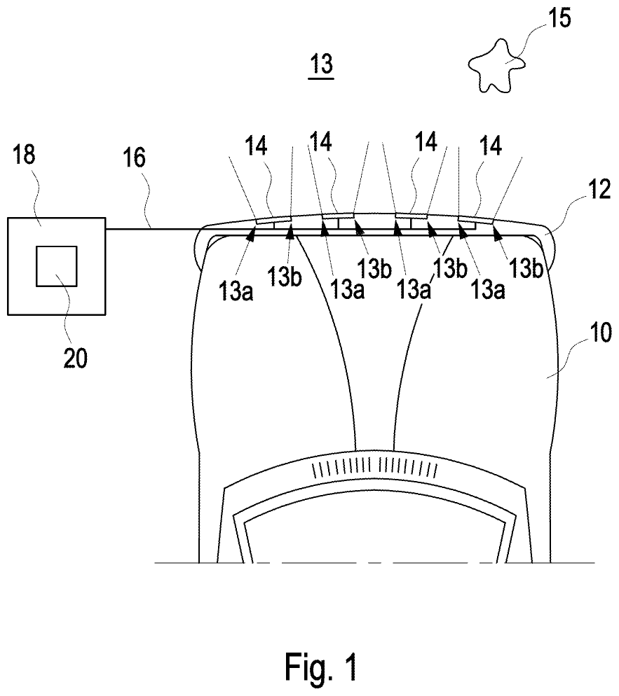

FIG. 1 illustrates a typical application for the examination of the environment of a vehicle by means of ultrasonic signals. FIG. 1 is a top plan view on the front of a vehicle 10, in the bumper 12 of which, in this example, four ultrasonic transducers 14 are arranged that alternately operate as ultrasonic transmitters (indicated by 13a) and ultrasonic receivers (indicated by 13b). These transmit ultrasonic burst signals into the area 13 of the front environment in which an object 15 may be present. A data communication bus 16 connects the ultrasonic transducers 14 to a control and evaluation unit 18 which is provided with a signal processing unit 20.

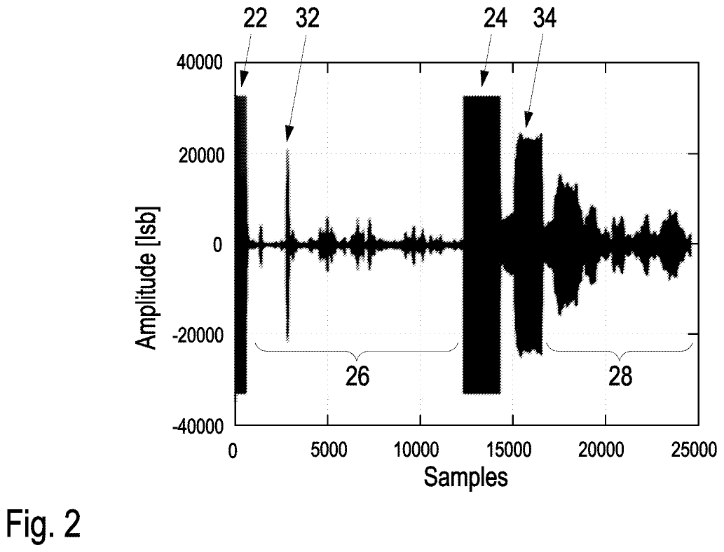

FIG. 2 illustrates the chronological sequence of the transmission of a first ultrasonic burst signal 22, which in the present case is a short signal, and the transmission of a second ultrasonic burst signal 24, which in the present case is a longer signal. The course of the echo signals 26, 28, which respectively follow the associated ultrasonic burst signal 22 or 24, is also illustrated. For clarification, the amplitude of the echo signals 26, 28 is significantly highlighted. Normally, the amplitude of the ultrasonic burst signals 22, 24 exciting the ultrasonic transducer 14 is significantly larger than that of the respective echo signals 26, 28.

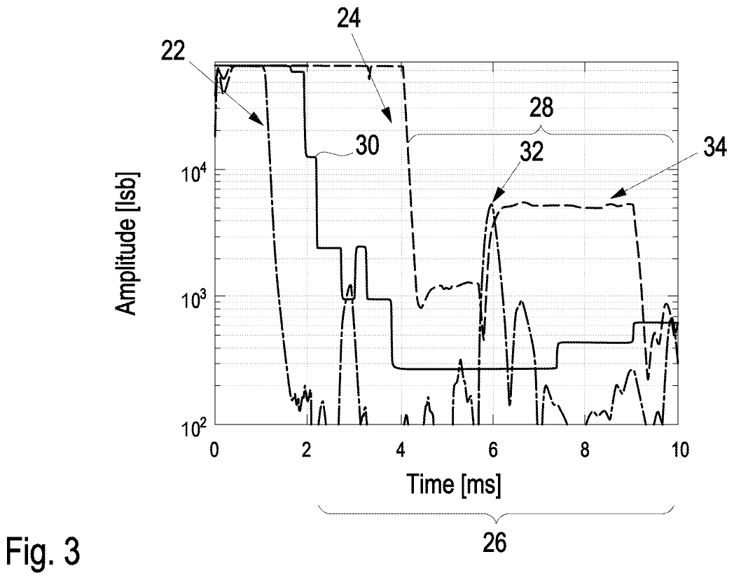

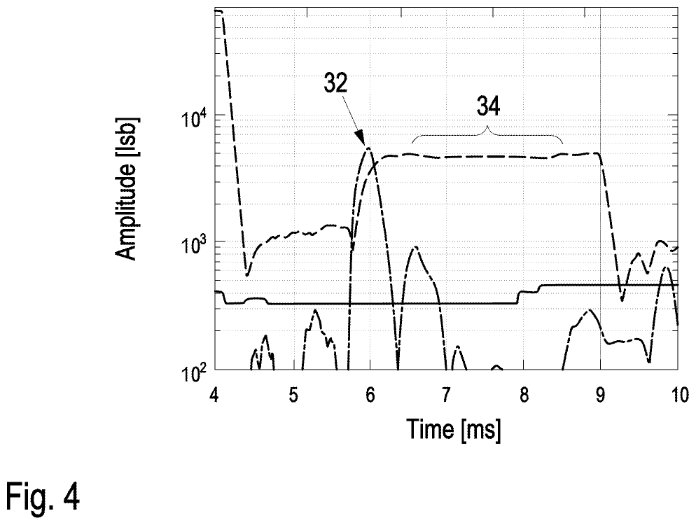

In order to clarify the method, the demodulated signals 22, 26 and 24, 28, i.e. the envelopes. are superposed in the diagram in FIG. 3. In this illustration, the two echo signals 26, 28 thus start at the same time, which, however, has been chosen such only for purposes of illustration. In FIG. 3, a solid line represents the envelope for the short ultrasonic burst signal 22 and the echo signal 26 thereof, whereas the envelope for the long ultrasonic burst signal 24 with the associated echo signal 28 is represented by a broken line. In addition, also the course of the specified threshold value 30 for the evaluation is illustrated by a chain dotted line. Only those signal components above the specified threshold value 30 are evaluated. An echo peak 32 indicating that an object has been detected can be seen in the echo signal 26 of the short ultrasonic burst signal 22. In this example, the echo peak 32 appears after about 6 ms from the start of transmission of the short ultrasonic burst signal 22. With regard to the echo signal 28 of the long ultrasonic burst signal 24, a plateau 34 exists in this echo signal 28 from the time of 6 ms on, which is used to determine the Doppler shift and to evaluate the same. The part of the curves of the diagram in FIG. 3, which is relevant in this respect, is again illustrated in FIG. 4.

Hereinafter, an example of the evaluation of both echo signals 26, 28 will be described.

First, the echo peaks of the short echo signal 26 which are above the specified threshold value 30 are determined. In a second step, the portion (plateau 34) in the long echo signal 28 is determined, in which the Doppler calculation is to be performed.

Due to various considerations, it is advantageous to directly calculate the Doppler calculation from the complex time signals, based on the calculation of the center of gravity of the spectrum (first spectral moment).

The method starts from the complex envelope signal which is present in the sensor in a time-discrete form:

Vₖ=Iₖ+jQₖ.

For the evaluation portion, the following sum is formed:

$$R = {\sum }_{k = 0}^{N - 1} {V}_{k} \cdot {V}_{k + 1}^{*} - {V}_{0} \cdot {V}_{N - 1}^{*}$$

The velocity results from the angle of R, as well as the wavelength λ and the sampling frequency Tₛₐₘₚₗₑ:

$$v = - \frac{λ}{4 π {T}_{Sample}} arg ( R )$$

If the calculation of R is performed not only for the duration of the long signal upon exceeding the threshold, but is performed across all values for the entire duration of the measurement, this corresponds to the center of the Doppler shift in the volume sensed by the sensor. Since, even without a clear obstacle, a significant signal portion above the threshold value is reflected by the ground (clutter), the velocity of the vehicle can be determined in this manner. If a plurality of obstacles is present, the one with the highest amplitude will be dominant. For a more detailed explanation thereof and of the entire method, V will be represented as polar coordinates.

V=|V|e^{jΦ}

For R, this results in (for simplicity, without correction term):

$$R = {\sum }_{k = 0}^{N - 1} \vert {V}_{k} \vert {e}^{j {Φ}_{k}} \cdot \vert {V}_{k + 1} \vert {e}^{- j {Φ}_{k + 1}} = {\sum }_{k = 0}^{N - 1} \vert {V}_{k} \vert \cdot \vert {V}_{k + 1} \vert {e}^{j ( {Φ}_{k} - {Φ}_{k + 1} )}$$

The phase difference in the exponent approximately describes the frequency at the position k:

$${f}_{k} \approx \frac{1}{2 π} \frac{{Φ}_{k} - {Φ}_{k + 1}}{{T}_{Sample}} = \frac{1}{2 π} \frac{Δ {Φ}_{k}}{{T}_{Sample}}$$

The frequency components are thus weighted by the square of their amplitudes.

### LIST OF REFERENCE SYMBOLS

10 vehicle
12 bumper
13 area in the environment of the vehicle
13a ultrasonic receiver
13b ultrasonic transmitter
14 ultrasonic transducer
15 object
16 data communication bus
18 evaluation unit
20 signal processing unit
22 shorter ultrasonic burst signal
24 longer ultrasonic burst signal
26 shorter echo signal
28 longer echo signal
30 specified threshold value
32 echo peak
34 plateau

What is claimed is:

1. A method for examining an environment of a vehicle by analyzing echo signals generated by reflection of transmitted ultrasonic signals at an object in the environment of the vehicle, the method comprising:
transmitting an ultrasonic burst signal with a first number of ultrasonic pulses following each other at a frequency and, timely offset from this ultrasonic burst signal, an ultrasonic burst signal with a second number of ultrasonic pulses following each other at a same or a different frequency respectively into a same area of the environment of the vehicle and in a same direction by an ultrasonic transmitter within repeating measuring cycles, the second number of ultrasonic pulses being different from the first number of ultrasonic pulses,
creating timely offset echo signals at an object potentially present in said area of the environment of the vehicle by reflection of the two ultrasonic burst signals, which echo signals are received by an ultrasonic receiver,
evaluating the echo signals of both ultrasonic burst signals to determine different parameters of an object potentially present in said area of the environment of the vehicle,
calculating a distance of an object potentially present in said area of the environment of the vehicle from the vehicle based on the echo signal of the ultrasonic burst signal with a lower number of ultrasonic pulses, and
calculating, based on the echo signal of the ultrasonic burst signal with a higher number of ultrasonic pulses, a velocity at which the vehicle and an object potentially present in said area of the environment of the vehicle move relative to each other in the direction of transmission of both ultrasonic burst signals or opposite thereto.

2. The method for examining the environment of a vehicle according to claim 1, wherein the analysis of the echo signals is performed using a signal processing unit.

3. The method for examining the environment of a vehicle according to claim 1, wherein as the ultrasonic transmitter and as the ultrasonic receiver, an ultrasonic transducer is used that fulfills the functions of both.

4. The method according to claim 1, wherein the ultrasonic burst signal with the lower number of pulses comprises 10 to 20 pulses, in particular 16 pulses, and/or a length of 190 μs to 380 μs, in particular 300 μs, and the ultrasonic burst signal with the higher number of pulses advantageously comprises 170 to 220 pulses, in particular 190 pulses, and/or a length of 3.2 ms to 4.0 ms, in particular 3.6 μs.

5. A device for examining an environment of a vehicle by analyzing echo signals generated by reflection of transmitted ultrasonic signals at an object in the environment of the vehicle, comprising:
an ultrasonic transmitter for a timely offset transmission of two ultrasonic burst signals in a same direction into a same area of the environment of the vehicle, the transmission occurring within repeating measuring cycles, one ultrasonic burst signal comprising a first number of ultrasonic pulses following each other at a frequency and the other ultrasonic burst signal comprising a second number of ultrasonic pulses different from the first number of ultrasonic pulses and following each other at the same or a different frequency,
an ultrasonic receiver for receiving echo signals of the two ultrasonic burst signals upon reflection at an object potentially present in said area of the environment of the vehicle,
a signal processing unit for evaluation of the two echo signals to determine different parameters of an object potentially present in said area of the environment of the vehicle,
a distance of an object potentially present in said area of the environment of the vehicle from the vehicle being calculated based on the echo signal of the ultrasonic burst signal with a lower number of ultrasonic pulses, and
based on the echo signal of the ultrasonic burst signal with a higher number of ultrasonic pulses, a velocity can be calculated at which the vehicle and an object potentially present in said area of the environment of the vehicle move relative to each other in the direction of the transmission of both ultrasonic burst signals or opposite thereto.

6. The device according to claim 5, wherein an ultrasonic transducer is designed as the ultrasonic transmitter and the ultrasonic receiver, the ultrasonic transducer fulfilling the functions of both.

7. The device according to claim 5, wherein the ultrasonic burst signal with the lower number of pulses comprises 10 to 20 pulses, in particular 16 pulses, and/or a length of 190 μs to 380 μs, in particular 300 μs, and the ultrasonic burst signal with the higher number of pulses advantageously comprises 170 to 220 pulses, in particular 190 pulses, and/or a length of 3.2 ms to 4.0 ms, in particular 3.6 μs.
